(19) United States
(12) Patent Application Publication
(10) Pub. No.: US 2020/0082795 A1
(43) Pub. Date: Mar. 12, 2020

(54) IMAGE DISPLAY DEVICE AND METHOD OF CONTROLLING SAME

(71) Applicant: SEIKO EPSON CORPORATION, Tokyo (JP)

(72) Inventor: Takahiro ANO, Matsumoto-shi (JP)

(73) Assignee: SEIKO EPSON CORPORATION, Tokyo (JP)

(21) Appl. No.: 16/561,387

(22) Filed: Sep. 5, 2019

(30) Foreign Application Priority Data
Sep. 6, 2018 (JP) 2018-166696

(51) Int. Cl. G09G 5/377; G06F 3/0354; G06F 3/042; G09G 5/373; G06F 3/0488

(52) U.S. Cl. CPC G09G 5/377; G06F 3/03542; G06F 3/042; G09G 5/373; G09G 2340/0407; G09G 2354/00; G09G 2340/12; G09G 2340/045; G09G 2340/0464; G06F 3/04883

(57) ABSTRACT

An image display device includes an image information input section to which a content image is input, a detection section for detecting a pointing position pointed by a light emitting pen on a projection surface, a drawn image generation section for generating a drawn image based on a trajectory of the pointing position detected by the detection section, an image information combining section for combining the drawn image with the content image, an image projection section for projecting the image combined by the image information combining section on the projection surface, an image information processing section for making a change to at least one of a size or a position of the content image, and an OSD processing section for making a change corresponding to the change to be made to the content image to the drawn image.

The present application is based on, and claims priority from JP Application Serial Number 2018-166696, filed Sep. 6, 2018, the disclosure of which is hereby incorporated by reference herein in its entirety.

### BACKGROUND

### 1. Technical Field

The present disclosure relates to an image display device and a method of controlling the image display device.

### 2. Related Art

There is known an image display device for displaying an on-screen display (OSD) image at the same time as a content image. As one of such image display devices, in JP-A-2015-176102 (Document 1), there is described an image projection device for displaying the OSD image at a position where the OSD image does not overlap the content image by moving or contracting the content image as needed when displaying the OSD image. According to this image projection device, since there is no chance for a part of the content image to be hidden by the OSD image, visibility of the content image is improved.

However, in the image display device capable of performing drawing so as to be superimposed on the content image with a pointing body such as a light emitting pen like a projector described in JP-A-2015-158887 (Document 2), there is provided a problem that there occurs a shift between the content image and an image thus drawn when the content image moves or contracts due to the display or the like of the OSD image.

### SUMMARY

An image display device according to an aspect of the present disclosure is an image display device configured to display an image on a display surface including an input section supplied with a first image, a detection section configured to detect a pointing position pointed with a pointing body above the display surface, a generation section configured to generate a second image based on a trajectory of the pointing position detected by the detection section, a combining section configured to combine the second image with the first image, a display section configured to display the first image and the second image combined with each other by the combining section on the display surface, a first processing section configured to change at least one of a size and a position of the first image supplied to the input section, and a second processing section configured to make a change corresponding to the change to be made to the first image by the first processing section to the second image generated by the generation section.

In the image display device described above, the second processing section may change a size of the second image when the size of the first image is changed.

In the image display device described above, the second processing section may change a position of the second image when the position of the first image is changed.

In the image display device described above, when displaying a third image next to the first image, the first processing section may change at least one of the size and the position of the first image so that the third image fails to overlap the first image.

In the image display device described above, the third image may be an operation image configured to assist an operation by a user.

In the image display device described above, the display section may have an image formation section in which the first image and the second image combined with each other by the combining section are formed, and the first processing section may change at least one of the size and the position of the first image when the first image and the third image overlap each other when disposing the third image in a peripheral area located outside the first image in the image formation section.

The image display device described above may further include a resolution information storage section configured to store resolution information corresponding to resolution of the image formation section, the first image may be input to the input section with the resolution based on the resolution information by an image supply device which obtains the resolution information from the resolution information storage section, and the first processing section may change the resolution information in accordance with resolution of an area obtained by excluding an area in which the third image is disposed from the image formation section when changing the size of the first image.

A method of controlling an image display device according to an aspect of the present disclosure is a method of controlling an image display device configured to display an image on a display surface, the method including the steps of receiving, by the image display device, supply of a first image, detecting, by the image display device, a pointing position pointed with a pointing body above the display surface, generating, by the image display device, a second image based on a trajectory of the pointing position, combining, by the image display device, the second image with the first image, displaying, by the image display device, the first image and the second image combined with each other on the display surface, and making, by the image display device, a change corresponding to a change made to the first image to the second image when making the change to at least one of a size and a position of the first image supplied.

In the method of controlling the image display device described above, when changing the size of the first image, the image display device may change a size of the second image.

In the method of controlling the image display device described above, when changing the position of the first image, the image display device may change a position of the second image.

In the method of controlling the image display device described above, when displaying a third image next to the first image, the image display device may change at least one of the size and the position of the first image so that the third image fails to overlap the first image.

In the method of controlling the image display device described above, the third image may be an operation image configured to assist an operation by a user.

In the method of controlling the image display device described above, the image display device may form the first image and the second image in an image formation section to thereby display the first image and the second image on the display surface, and the image display device may change at least one of the size and the position of the first image when the first image and the third image overlap each other when disposing the third image in a peripheral area located outside the first image in the image formation section.

In the method of controlling the image display device described above, the image display device further may include a resolution information storage section configured to store resolution information corresponding to resolution of the image formation section, the image display device may receive supply of the first image with the resolution based on the resolution information by an image supply device which obtains the resolution information from the resolution information storage section, and the image display device may change the resolution information in accordance with resolution of an area obtained by excluding an area in which the third image is disposed from the image formation section when changing the size of the first image.

### BRIEF DESCRIPTION OF THE DRAWINGS

FIG. 1 is a perspective view showing an image display system.

FIG. 2 is a block diagram showing a schematic configuration of a projector.

FIG. 3 is a block diagram showing a schematic configuration of an image projection section provided to the projector.

FIG. 4A is an explanatory diagram for explaining a size adjustment function, and is a diagram showing a pixel area of a liquid crystal light valve.

FIG. 4B is an explanatory diagram for explaining the size adjustment function, and a diagram showing a projection image projected on a projection surface.

FIG. 5A is an explanatory diagram for explaining the size adjustment function, and is a diagram showing the pixel area of the liquid crystal light valve.

FIG. 5B is an explanatory diagram for explaining the size adjustment function, and a diagram showing a projection image projected on the projection surface.

FIG. 6A is an explanatory diagram for explaining a position adjustment function, and is a diagram showing the pixel area of the liquid crystal light valve.

FIG. 6B is an explanatory diagram for explaining the position adjustment function, and a diagram showing the projection image projected on the projection surface.

FIG. 7A is an explanatory diagram for explaining the position adjustment function, and is a diagram showing the pixel area of the liquid crystal light valve.

FIG. 7B is an explanatory diagram for explaining the position adjustment function, and a diagram showing the projection image projected on the projection surface.

FIG. 8A is an explanatory diagram for explaining a toolbar, and is a diagram showing the pixel area in a state in which the toolbar is hidden.

FIG. 8B is an explanatory diagram for explaining the toolbar, and is a diagram showing the pixel area in a state in which the toolbar is displayed.

FIG. 9A is an explanatory diagram for explaining a layout of the toolbar, and is a diagram showing the pixel area in the state in which the toolbar is hidden.

FIG. 9B is an explanatory diagram for explaining the layout of the toolbar, and is a diagram showing the pixel area in the state in which the toolbar is displayed.

FIG. 10A is an explanatory diagram for explaining the layout of the toolbar, and is a diagram showing the pixel area in the state in which the toolbar is hidden.

FIG. 10B is an explanatory diagram for explaining the layout of the toolbar, and is a diagram showing the pixel area in the state in which the toolbar is displayed.

FIG. 11 is a flowchart for explaining an operation of the projector when displaying the toolbar.

FIG. 12 is an explanatory diagram for explaining an operation of the projector, and is a diagram showing the pixel area.

FIG. 13 is an explanatory diagram for explaining the operation of the projector, and is a diagram showing the pixel area.

FIG. 14 is an explanatory diagram for explaining the operation of the projector, and is a diagram showing the pixel area.

FIG. 15 is a flowchart showing the operation of the projector when the resolution of the content image has changed.

FIG. 16A is an explanatory diagram for explaining an operation of a projector according to a modified example, and is a diagram showing a pixel area in a state in which a content image is displayed alone.

FIG. 16B is an explanatory diagram for explaining the operation of the projector according to the modified example, and is a diagram showing the pixel area in a state in which a plurality of content images is displayed side by side.

### DESCRIPTION OF AN EXEMPLARY EMBODIMENT

An image display system according to the present embodiment will hereinafter be described with reference to the drawings.

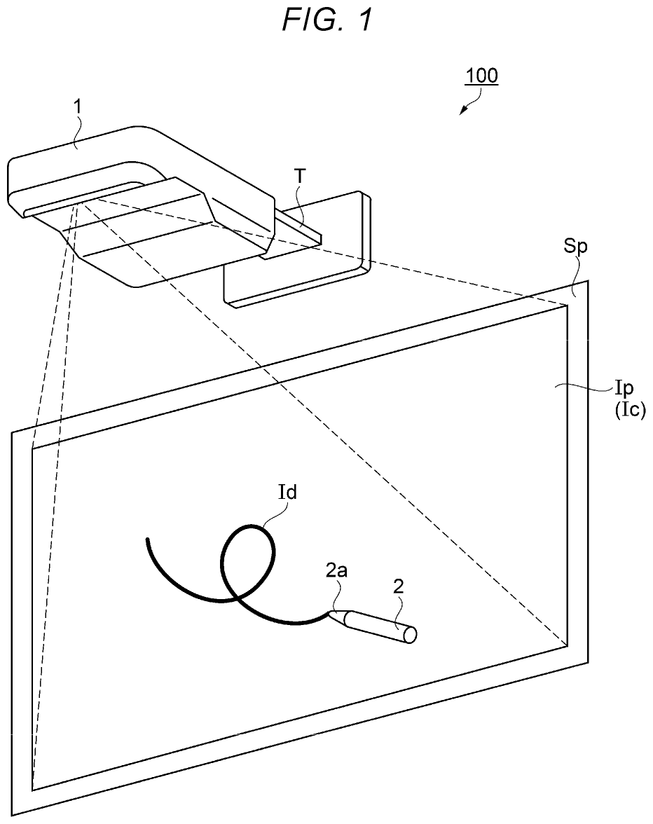

FIG. 1 is a perspective view showing the image display system 100 according to the present embodiment.

As shown in FIG. 1, the image display system 100 is provided with a projector 1 as an image display device, and a light emitting pen 2 as a pointing body. The projector 1 projects an image on a projection surface Sp as a display surface to thereby display the image. The projection image Ip to be projected from the projector 1 includes an image Ic related to the content as a viewing target. Hereinafter, the image Ic is also described as a “content image Ic.” The projector 1 according to the present embodiment is fixed to a wall surface via a fixation member T, and projects an image toward the projection surface Sp disposed along the same wall surface. As the projection surface Sp, there can be used, for example, a screen or a whiteboard, but it is also possible to adopt a configuration of projecting the image on the wall surface itself.

The light emitting pen 2 is provided with a light emitting section 2a for emitting infrared light disposed in a tip part, and at the same time, provided with a pressing detection section not shown for detecting pressing against the projection surface Sp with the tip part, namely a touch on the projection surface Sp. The light emitting section 2a repeats blinking in a predetermined light emitting sequence while the light emitting pen 2 is in operation. Then, the light emitting section 2a switches the light emitting sequence in accordance with presence or absence of the touch on the projection surface Sp. Therefore, it is possible for the projector 1 to identify presence or absence of the touch with the light emitting pen 2 based on the light emitting sequence of the light emitting section 2a. It should be noted that it is also possible for the light emitting pen 2 to have a configuration of emitting light in a wavelength band other than that of the infrared light.

The projector 1 is made capable of taking an image of a range including the projection image Ip. The projector 1 detects the light emitted by the light emitting pen 2 out of the image thus taken to detect the position of the light thus detected as the pointing position pointed by the light emitting pen 2. Further, the projector 1 detects presence or absence of the touch on the projection surface Sp based on the light emitting sequence of the light thus detected. Further, it is possible for the projector 1 to display a pointer not shown so as to be superimposed on the pointing position thus detected, or to display an image Id in which a line is drawn along the trajectory of the pointing position in the touched state so as to be superimposed. Hereinafter, the image Id is also described as a “drawn image Id.”

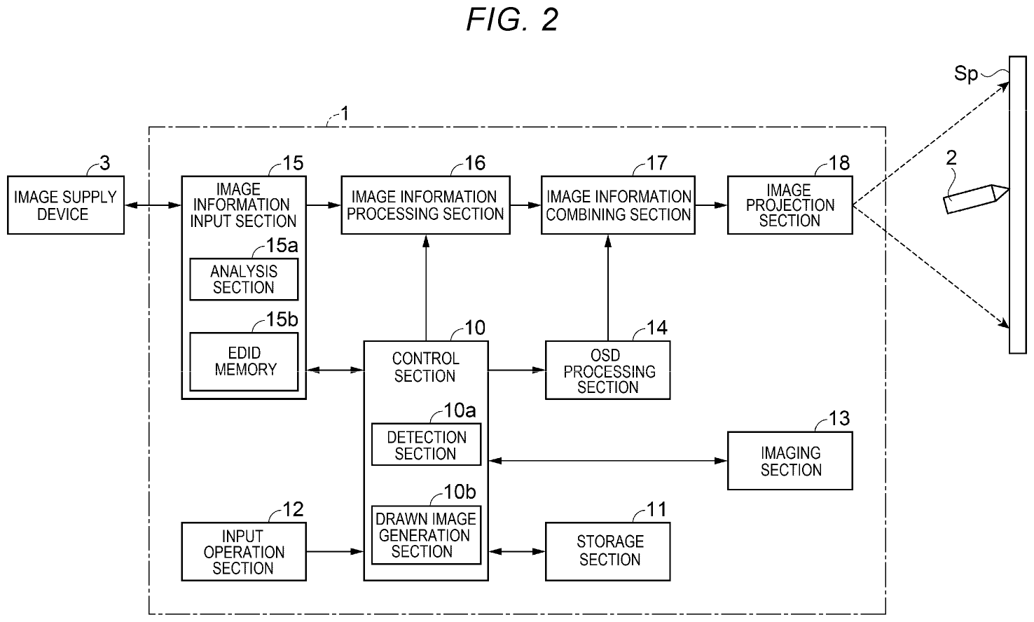

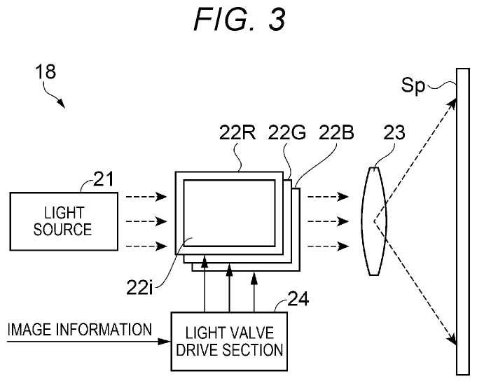

FIG. 2 is a block diagram showing a schematic configuration of the projector 1, and FIG. 3 is a block diagram showing a schematic configuration of an image projection section 18 provided to the projector 1.

As shown in FIG. 2, the projector 1 is configured integrally including a control section 10, a storage section 11, an input operation section 12, an imaging section 13, an OSD processing section 14 as a second processing section, an image information input section 15 as an input section, an image information processing section 16 as a first processing section, an image information combining section 17 as a combining section, and an image projection section 18 as a display section. The projector 1 projects an image from the image projection section 18 on the projection surface Sp based on the image information input to the image information input section 15.

The control section 10 is configured including one processor or a plurality of processors, and operates in accordance with a control program stored in the storage section 11 to thereby integrally control the operation of the projector 1.

The storage section 11 is configured including memory devices such as a random access memory (RAM) and a read only memory (ROM). The RAM is used for temporary storage of a variety of types of data, and the ROM stores the control program, control data and so on for controlling the operation of the projector 1. Further, it is also possible for the storage section 11 to store the image information to be projected from the image projection section 18.

The input operation section 12 is provided with a plurality of operation keys for the user to make a variety of instructions to the projector 1. As the operation keys provided to the input operation section 12, there are cited a “power key” for switching between ON and OFF of the power, a “menu key” for displaying a menu image for performing a variety of types of settings, “directional keys” for selecting items on the menu image, and so on. When the user operates a variety of operation keys of the input operation section 12, the input operation section 12 outputs an operation signal corresponding to the operation content by the user to the control section 10. It should be noted that it is also possible to adopt a configuration of using a remote controller not shown capable of a remote operation as the input operation section 12. In this case, the remote controller transmits an operation signal of an infrared ray corresponding to the operation content by the user, and then a remote control signal receiving section not shown receives the operation signal to transmit the operation signal to the control section 10.

The imaging section 13 is a camera provided with an imaging element not shown such as a CCD (charge coupled device) sensor or a CMOS (complementary metal oxide semiconductor) sensor. The imaging section 13 has an infrared transmission filter for absorbing visible light and transmitting infrared light, and images the infrared light emitted from the light emitting pen 2 via the infrared transmission filter. The imaging section 13 takes the image of a range including the projection image Ip on the projection surface Sp based on the control by the control section 10, and then outputs image information as the imaging result to the control section 10. Hereinafter, the image information output by the imaging section 13 is also described as “taken image information.”

The control section 10 of the projector 1 is provided with a detection section 10a and a drawn image generation section 10b as a generation section as functional blocks realized by the control program.

The detection section 10a detects the infrared light emitted by the light emitting pen 2 out of the image thus taken based on the taken image information input from the imaging section 13. The detection section 10a regards a figure having a luminance not lower than a predetermined threshold value and a size not smaller than a predetermined threshold value out of the figures of the infrared light included in the image thus taken as the light emitted by the light emitting pen 2, and detects the position of the figure as the pointing position of the light emitting pen 2. Further, the detection section 10a determines the light emitting sequence of the light emitting pen 2 based on the taken image information taken a plurality of number of times, and then detects presence or absence of the touch on the projection surface Sp.

The drawn image generation section 10b generates the drawn image Id in which the line is drawn along the trajectory of the pointing position based on the detection result of the detection section 10a. Specifically, when the pointing position has changed in the state in which the light emitting pen 2 keeps touching on the projection surface Sp, the drawn image generation section 10b generates image information representing the drawn image Id based on the trajectory of the pointing position. The image information is generated in, for example, a vector format, and is stored in the storage section 11 as needed. Further, the drawn image generation section 10b converts the image information in the vector format into that in a raster format to output to the OSD processing section 14.

The OSD processing section 14 is configured including a frame memory not shown. The OSD processing section 14 generates image information of a variety of types of OSD (on-screen display) images to be displayed at the same time as the content image Ic on the frame memory based on the control by the control section 10. The OSD image includes a menu image to be displayed when the menu key has been operated, a message image for announcing a variety of messages and so on in addition to a pointer to be displayed at the pointing position and the drawn image Id generated by the drawn image generation section 10b.

The image information input section 15 is coupled to an image supply device 3 located outside such as a computer or an image reproduction device, and is supplied with the image information corresponding to the content image Ic from the image supply device 3. Further, it is also possible for the image information input section 15 to be supplied with image information stored in the storage section 11 from the control section 10. The image information thus input is output by the image information input section 15 to the image information processing section 16.

The image information input section 15 includes an analysis section 15a. The analysis section 15a analyzes the image information input from the image supply device 3 to obtain information related to the content image Ic such as resolution represented by the number of pixels in the vertical and horizontal directions. The analysis section 15a outputs the information thus obtained to the control section 10.

Further, the image information input section 15 includes an EDID (extended display identification data) memory 15b for storing the EDID. The EDID is information representing the resolution and so on which the projector 1 deals with, and is retrieved by the image supply device 3 coupled to the image information input section 15. By obtaining the EDID from the EDID memory 15b, it becomes possible for the image supply device 3 to supply the image information with the resolution suitable for the projector 1. The EDID corresponds to the resolution information, and the EDID memory 15b corresponds to a resolution information storage section.

The image information processing section 16 is configured including a frame memory not shown. The image information processing section 16 stores the image information of the content image Ic input from the image information input section 15 in the frame memory, and at the same time, performs a variety of processes on the image information on the frame memory based on the control by the control section 10 to output the image information on which the processes have been performed to the image information combining section 17. For example, the image information processing section 16 performs a process of adjusting the image quality such as brightness or contrast, a process of correcting a distortion of the image, a process of adjusting the size or the position of the image, and the like on the image information as needed.

The image information combining section 17 performs a process of combining (superimposing) the OSD image with the content image Ic based on the control by the control section 10. Specifically, the image information combining section 17 combines the image information of the content image Ic input from the image information processing section 16 and the image information of the OSD image input from the OSD processing section 14 with each other. Specifically, defining the content image Ic stored in the frame memory of the image information processing section 16 as a first layer, and the OSD image stored in the frame memory of the OSD processing section 14 as a second layer, the image information combining section 17 performs a process of superimposing the first layer and the second layer on each other. The image information combining section 17 outputs the image information having been combined to a light valve drive section 24 (see FIG. 3) of the image projection section 18.

It should be noted that the OSD processing section 14, the image information input section 15, the image information processing section 16 and the image information combining section 17 can be constituted by a single processor or a plurality of processors and so on, or can also be constituted by a dedicated processing device such as an ASIC (application specific integrated circuit) or an FPGA (field programmable gate array).

As shown in FIG. 3, the image projection section 18 is configured including a light source 21, three liquid crystal light valves 22R, 22G and 22B as light modulation devices, a projection optical system 23, the light valve drive section 24 and so on. The image projection section 18 modulates the light emitted from the light source 21 with the liquid crystal light valves 22R, 22G and 22B to thereby form image light, and then projects the image light from the projection optical system 23 including at least one of a lens and a mirror to thereby display the image on the projection surface Sp.

The light source 21 is configured including a discharge type light source lamp such as a super high-pressure mercury lamp or a metal halide lamp, or a solid-state light source such as a light emitting diode or a semiconductor laser. The light emitted from the light source 21 is converted into the light having a substantially uniform intensity distribution by an integrator optical system not shown, and is then separated into colored light components of red (R), green (G) and blue (B), the three primary colors of light, by a color separation optical system not shown, and then the colored light components respectively enter the liquid crystal light valves 22R, 22G and 22B.

The liquid crystal light valves 22R, 22G and 22B are each formed of a transmissive liquid crystal panel having a liquid crystal material encapsulated between a pair of transparent substrates, and so on. The liquid crystal panels are each provided with a rectangular pixel area 22i constituted by a plurality of pixels arranged in a matrix, and are each arranged so that a drive voltage can be applied to the liquid crystal material pixel by pixel. The pixel area 22i corresponds to an image formation section.

The light valve drive section 24 forms an image in the pixel area 22i of each of the liquid crystal light valves 22R, 22G and 22B. Specifically, the light valve drive section 24 applies the drive voltages corresponding to the image information input from the image information combining section 17 to the respective pixels in the pixel areas 22i to thereby set the pixels to respective light transmission rates corresponding to the image information. The light emitted from the light source device 21 is transmitted through the pixel area 22i of each of the liquid crystal light valves 22R, 22G and 22B to thereby be modulated pixel by pixel, and thus the image light corresponding to the image information is formed for each of the colored light beams. The light beams as the image light of the respective colors thus formed are combined with each other pixel by pixel by a color composition optical system not shown to turn to the image light representing a color image, and the image light is then projected on the projection surface Sp by the projection optical system 23 in an enlarged manner. As a result, on the projection surface Sp, there is displayed the projection image Ip including the content image Ic and the OSD image such as the drawn image Id.

The projector 1 according to the present embodiment is configured so as to be able to perform the size adjustment function and the position adjustment function due to the cooperation between the control section 10 and the image information processing section 16. The size adjustment function is a function of adjusting the size of the content image Ic on the projection surface Sp, namely the scale size of the content image Ic, and the position adjustment function is a function of adjusting the position of the content image Ic on the projection surface Sp.

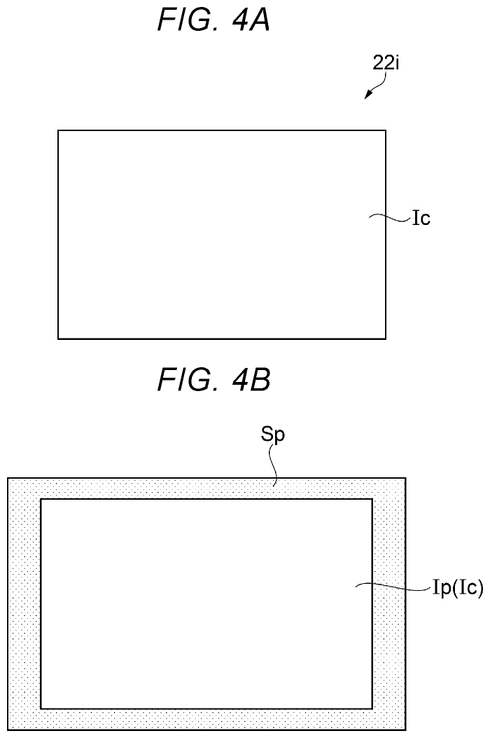

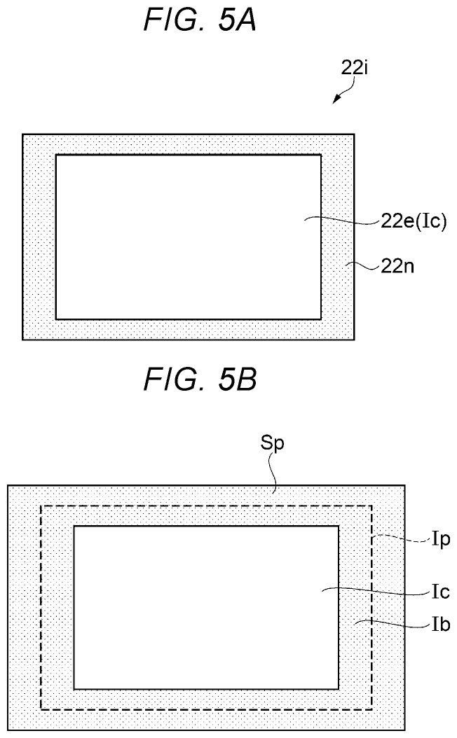

FIG. 4A, FIG. 4B, FIG. 5A and FIG. 5B are explanatory diagrams for explaining the size adjustment function. Among the above, FIG. 4A and FIG. 5A are diagrams showing the pixel area 22i of each of the liquid crystal light valves 22R, 22G and 22B, and FIG. 4B and FIG. 5B are diagrams showing the projection image Ip projected on the projection surface Sp.

In order to display the content image Ic in a large size with high resolution, it is desirable to form the content image Ic using the entire area of the pixel area 22i as shown in FIG. 4A and FIG. 4B. It should be noted that when attempting to display the content image Ic in a smaller size as needed, it is possible to contract the content image Ic using the size adjustment function.

As shown in FIG. 5A and FIG. 5B, the size adjustment function is a function of setting a valid area 22e having a rectangular shape smaller in size than the pixel area 22i within the pixel area 22i, and forming the content image Ic in the valid area 22e to thereby adjust the size of the content image Ic. When the control section 10 outputs a size adjustment value representing the size of the content image Ic to the image information processing section 16, the image information processing section 16 performs a process of changing the size of the content image Ic in accordance with the size adjustment value thus input. It should be noted that the size adjustment value output to the image information processing section 16 is stored in the storage section 11 by the control section 10.

When the size adjustment value is input from the control section 10, the image information processing section 16 sets the valid area 22e having a size corresponding to the size adjustment value in the pixel area 22i, and performs a process for forming the image within the valid area 22e thus set on the image information input from the image information input section 15. Specifically, the image information processing section 16 thereafter thins the image information input from the image information input section 15 to contract the content image Ic in order to form the content image Ic within the valid area 22e thus set. Further, the image information processing section 16 sets the color of a peripheral area 22n as an area outside the valid area 22e to black, namely the color minimizing the light transmission rate. As a result, it becomes possible to display the content image Ic in a smaller size compared to when forming the content image Ic in the entire area of the pixel area 22i as shown in FIG. 5B. On this occasion, the area Ib outside the content image Ic, namely the area Ib corresponding to the peripheral area 22n, is set to black, and is therefore made difficult to be visually recognized by the user.

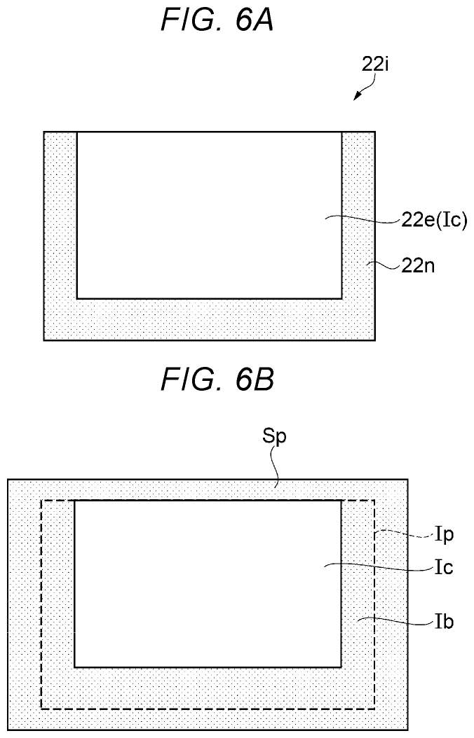

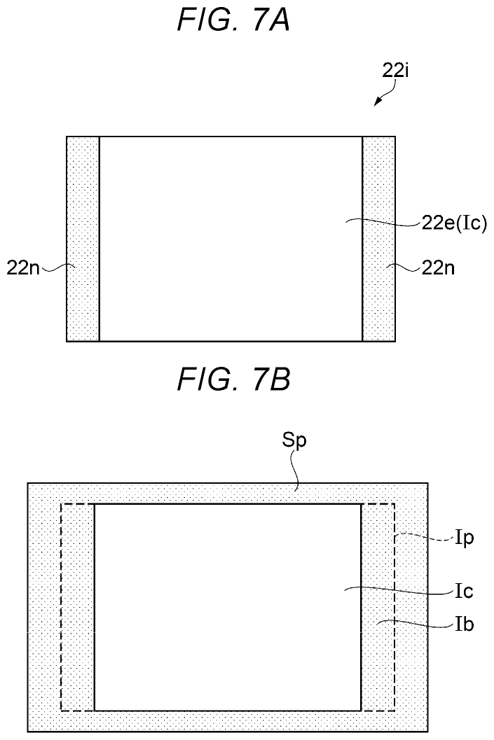

FIG. 6A, FIG. 6B, FIG. 7A and FIG. 7B are explanatory diagrams for explaining the position adjustment function, wherein FIG. 6A and FIG. 7A are diagrams showing the pixel area 22i of each of the liquid crystal light valves 22R, 22G and 22B, and FIG. 6B and FIG. 7B are diagrams showing the projection image Ip projected on the projection surface Sp.

As shown in FIG. 5A, the position adjustment function is a function of adjusting the position of the content image Ic on the projection surface Sp by changing the position of the valid area 22e in the pixel area 22i when the peripheral area 22n exists outside the content image Ic. When the control section 10 outputs coordinate information representing a coordinate of a predetermined reference position of the valid area 22e to the image information processing section 16, the image information processing section 16 performs a process for changing the position of the valid area 22e in accordance with the coordinate information thus input. The predetermined reference position is, for example, the center of the valid area 22e. It should be noted that the coordinate information output to the image information processing section 16 is stored in the storage section 11 by the control section 10.

As shown in FIG. 6A, when the coordinate information is input from the control section 10, the image information processing section 16 changes the position of the valid area 22e based on the coordinate information. Specifically, the image information processing section 16 sets the valid area 22e at the position based on the coordinate information thus input within the pixel area 22i, and then performs a process for forming the image within the valid area 22e thus set on the image information input from the image information input section 15. As a result, the content image Ic is displayed on the projection surface Sp in the state of being moved to the position based on the coordinate information as shown in FIG. 6B. FIG. 6A and FIG. 6B show when the content image Ic has moved upward from the state shown in FIG. 5A and FIG. 5B, respectively.

It should be noted that as shown in FIG. 7A and FIG. 7B, when the aspect ratio is different between the content image Ic and the pixel area 22i, the projector 1 provides black areas on the right side and the left side, or the upper side and the lower side of the content image Ic. These areas also correspond to the peripheral area 22n. In other words, when the aspect ratio is different between the content image Ic and the pixel area 22i, since the peripheral area 22n is formed outside the content image Ic even when displaying the content image Ic in the maximum size, it is possible to move the content image Ic in a direction in which the peripheral area 22n is formed. In the example shown in FIG. 7A and FIG. 7B, since the peripheral areas 22n are formed on both of the right side and the left side of the content image Ic, it is possible to move the content image Ic in the horizontal direction.

Further, the projector 1 according to the present embodiment is arranged to be able to display a toolbar Pt as an operation image for assisting a variety of operations by the user next to the content image Ic when projecting the content image Ic. The toolbar Pt is one of the OSD images generated by the OSD processing section 14, and is combined with the content image Ic by the image information combining section 17.

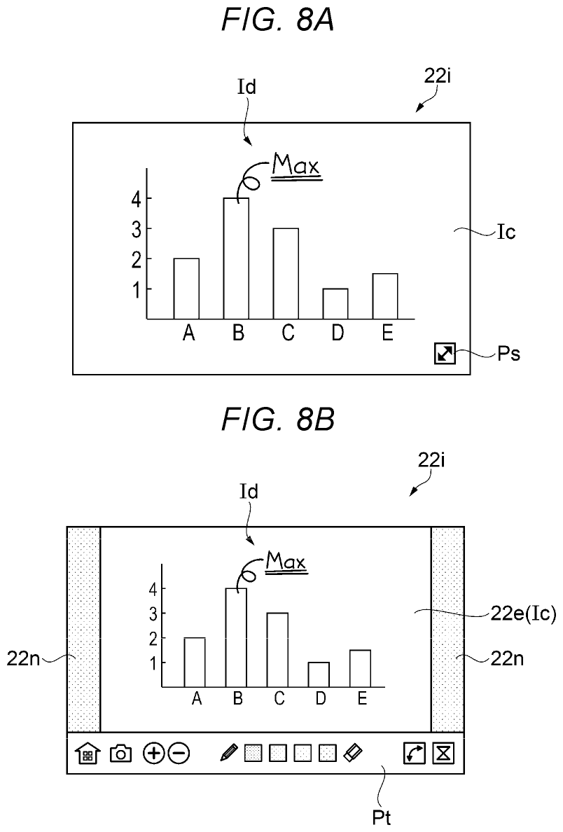

FIG. 8A and FIG. 8B are explanatory diagrams for explaining the toolbar Pt, wherein FIG. 8A is a diagram showing the pixel area 22i in the state in which the toolbar Pt is hidden, and FIG. 8B is a diagram showing the pixel area 22i in the state in which the toolbar Pt is displayed. It should be noted that FIG. 8A shows the state in which the contraction of the content image Ic by the size adjustment function is not performed, namely the state in which the content image Ic is formed in the entire area of the pixel area 22i.

As shown in FIG. 8A, in the state in which the toolbar Pt is hidden, a button image Ps small in size and having a rectangular shape is disposed in one corner part of the content image Ic. By touching the button image Ps projected on the projection surface Sp with the light emitting pen 2, it is possible for the user to make the toolbar Pt be displayed.

As shown in FIG. 8B, when the button image Ps is touched by the user, the toolbar Pt having an elongated shape is disposed along one side of the pixel area 22i. In the example of FIG. 8B, the toolbar Pt is disposed along the lower side of the pixel area 22i. The toolbar Pt includes a plurality of icons, and by touching a desired icon in the toolbar Pt projected on the projection surface Sp with the light emitting pen 2, it is possible for the user to make the projector 1 perform the process corresponding to the icon.

For example, in the area on the left side in the toolbar Pt, there are arranged icons related to basic operations of the projector 1 such as an icon for displaying a predetermined home screen or an icon for capturing and then storing the projection image Ip. Further, in a central area in the toolbar Pt, there are arranged icons related to a drawing operation such as icons for designating the drawing color when performing drawing with the light emitting pen 2. Further, in a right side area in the toolbar Pt, there are arranged an icon for changing the position of the toolbar Pt and an icon for restoring the toolbar Pt to nondisplay. It becomes possible for the user to easily designate a variety of processes by touching the desired icon on the projection surface Sp as needed.

In the storage section 11 of the projector 1, there is stored toolbar information representing the display state of the toolbar Pt, namely whether the state in which the toolbar Pt is currently displayed or the state in which the toolbar Pt is hidden, and the toolbar information is updated every time the display state is switched.

The position where the toolbar Pt is disposed is not fixed to the position along a specific side of the pixel area 22i, but can also be changed to a position along another side. For example, the projector 1 sequentially changes the display position of the toolbar Pt in such a manner as the lower side→the right side→the upper side→the left side→the lower side→every time the icon for changing the position of the toolbar Pt is touched with the light emitting pen 2. The toolbar information described above includes position information representing the display position of the toolbar Pt, and the position information is updated in accordance with the display position of the toolbar Pt.

When displaying the toolbar Pt, the projector 1 according to the present embodiment disposes the toolbar Pt in the peripheral area 22n located outside the content image Ic so as to prevent the toolbar Pt from overlapping the content image Ic to hide a part of the content image Ic. It should be noted that when the peripheral area 22n does not exist as shown in FIG. 8A, or when the peripheral area 22n does not have a width enough for disposing the toolbar Pt, the projector 1 performs contraction or translation of the content image Ic to thereby prepare the peripheral area 22n having the necessary size. Specifically, as shown in FIG. 8B, the projector 1 contracts the content image Ic with the size adjustment function or moves the content image Ic to a position where the content image Ic does not overlap the toolbar Pt with the position adjustment function as needed in order to make it possible to dispose the toolbar Pt along one of the sides of the pixel area 22i.

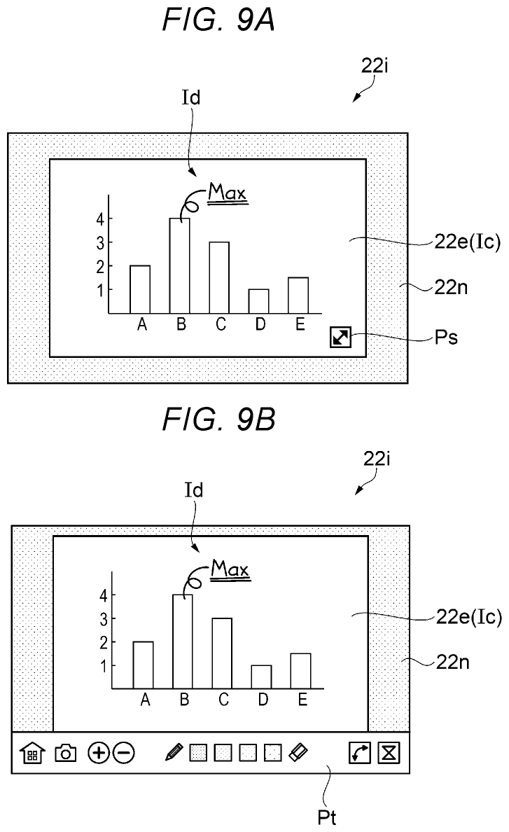

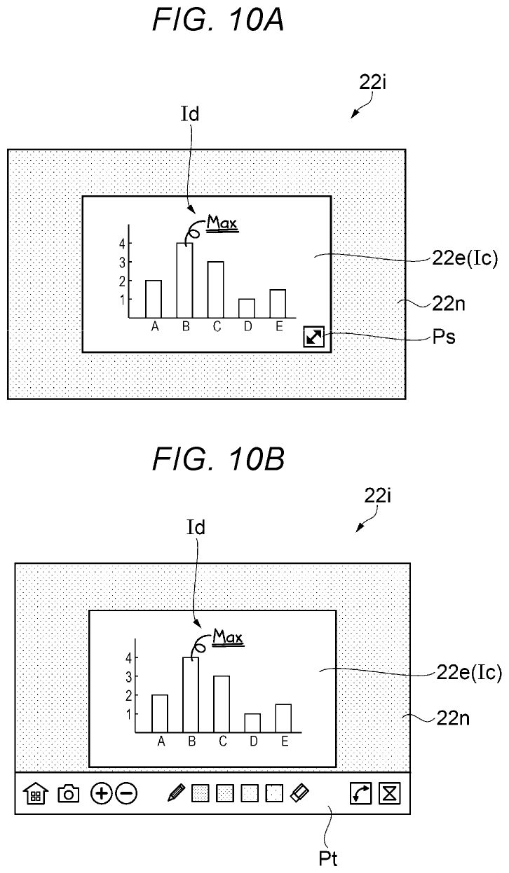

FIG. 9A, FIG. 9B, FIG. 10A and FIG. 10B are explanatory diagrams for explaining the layout of the toolbar Pt, wherein FIG. 9A and FIG. 10A are diagrams showing the pixel area 22i in the state in which the toolbar Pt is hidden, and FIG. 9B and FIG. 10B are diagrams showing the pixel area 22i in the state in which the toolbar Pt is displayed.

When the content image Ic has already been displayed in a contracted manner with the size adjustment function, or when the peripheral area 22n having a sufficiently large width exists outside the content image Ic in the pixel area 22i due to the difference in aspect ratio between the content image Ic and the pixel area 22i as shown in FIG. 9A and FIG. 10A, the projector 1 does not perform the contraction of the content image Ic.

For example, when it is possible to avoid the overlap between the content image Ic and the toolbar Pt only by moving the content image Ic as shown in FIG. 9A, the projector 1 moves the content image Ic, but does not perform the contraction as shown in FIG. 9B. Further, when the peripheral area 22n located outside the content image Ic has a sufficiently large width, and the toolbar Pt can be disposed without moving the content image Ic as shown in FIG. 10A, the projector 1 disposes the toolbar Pt without performing the contraction or the translation of the content image Ic.

When the content image Ic contracts or moves in accordance with the display of the toolbar Pt as shown in FIG. 8B and FIG. 9B, the projector 1 also performs the contraction or the translation in substantially the same manner on the drawn image Id having been already drawn with the light emitting pen 2.

The OSD processing section 14 sets a drawing area on the frame memory and then forms the drawn image Id on the drawing area in accordance with the size and the position of the content image Ic in the pixel area 22i. Therefore, when the size or the position of the content image Ic is changed by the image information processing section 16, the OSD processing section 14 changes the size of the drawing area in accordance with the change in size of the content image Ic, or changes the position of the drawing area in accordance with the change in position of the content image Ic. Further, the OSD processing section 14 changes the size and the position of the drawn image Id having already been drawn in accordance with the change of the drawing area. Thus, the content image Ic and the drawn image Id change in an interlocking manner without misalignment. In other words, the OSD processing section 14 makes a change corresponding to the change made to the content image Ic to the drawn image Id in tandem with the change in size or position of the content image Ic.

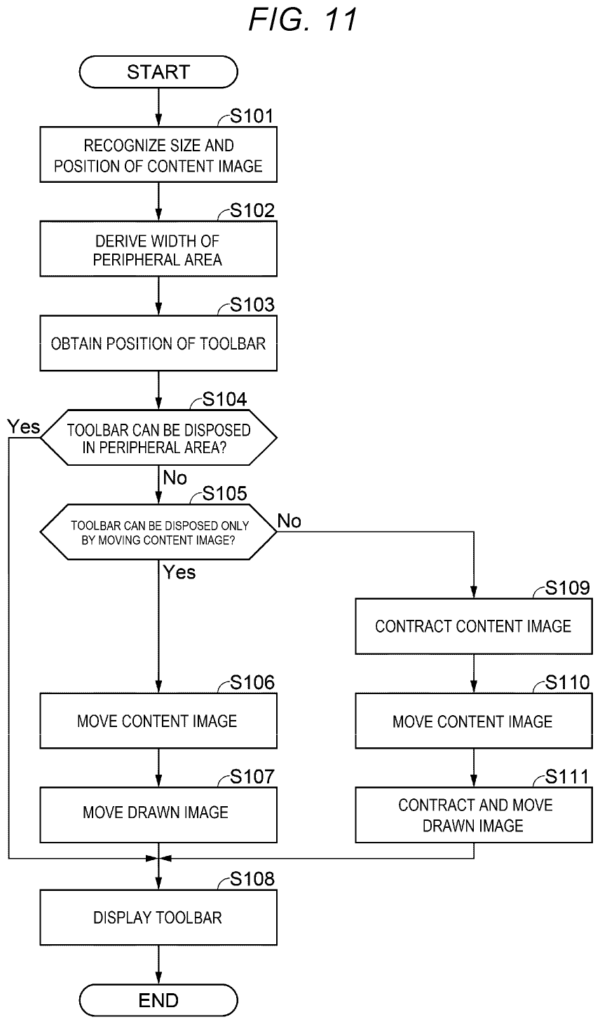

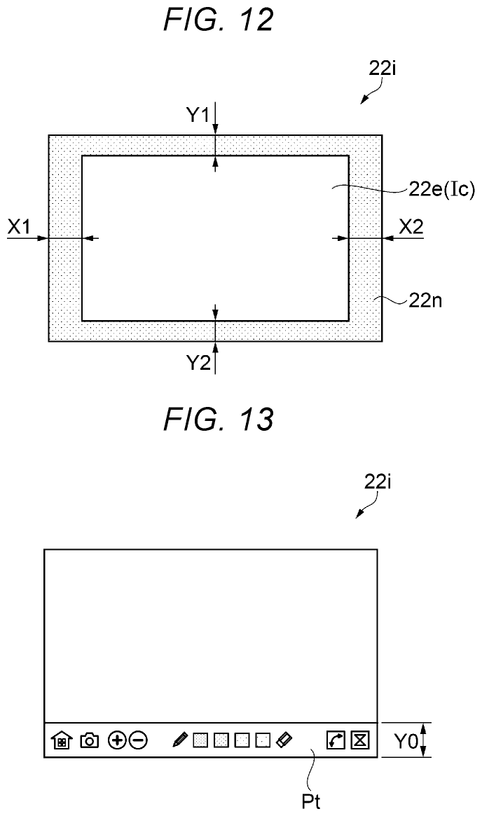

FIG. 11 is a flowchart for explaining an operation of the projector 1, namely a method of controlling the projector 1 when displaying the toolbar Pt. Further, FIG. 12 through FIG. 14 are explanatory diagrams for explaining the operation of the projector 1, and are diagrams showing the pixel area 22i. When the button image Ps is touched with the light emitting pen 2 in the state in which the toolbar Pt is hidden, the control section 10 of the projector 1 starts the operation in accordance with the flow shown in FIG. 11.

As shown in FIG. 11, in the step S101, the control section 10 recognizes the size and the position of the content image Ic in the pixel area 22i based on the resolution of the content image Ic obtained by the analysis section 15a, the size adjustment value in the size adjustment function, the coordinate information in the position adjustment function.

In the step S102, the control section 10 derives the width of the peripheral area 22n located outside the content image Ic in the pixel area 22i based on the size and the position of the content image Ic. Specifically, as shown in FIG. 12, the control section 10 derives a width Y1 as a distance between the content image Ic and the upper side of the pixel area 22i, a width Y2 as a distance between the content image Ic and the lower side thereof, a width X1 as a distance between the content image Ic and the left side thereof, and a width X2 as a distance between the content image Ic and the right side thereof. It should be noted that the control section 10 deriving the width of the peripheral area 22n in the step S102 corresponds to a derivation section.

In the step S103, the control section 10 retrieves the toolbar information stored in the storage section 11 to obtain the position information representing the display position of the toolbar Pt.

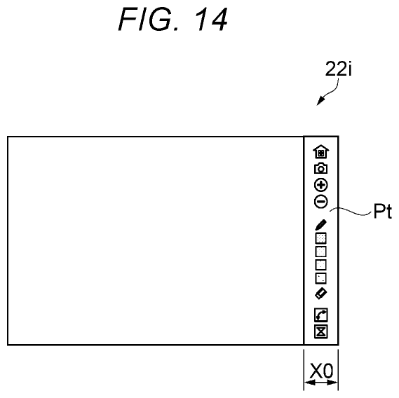

In the step S104, the control section 10 determines whether or not the width of the peripheral area 22n is sufficient to dispose the toolbar Pt. Specifically, the control section 10 compares the widths X1, X2, Y1 and Y2 of the peripheral areas 22n obtained in the step S102 with the width Y0 (see FIG. 13) of the toolbar Pt when disposing the toolbar Pt on the lower side or the upper side of the pixel area 22i, or the width X0 (see FIG. 14) of the toolbar Pt when disposing the toolbar Pt on the left side or the right side of the pixel area 22i. Then, when the control section 10 dispose the toolbar Pt at the position represented by the position information obtained in the step S103, the control section 10 determines whether or not the toolbar Pt can be disposed without overlapping the content image Ic. For example, when disposing the toolbar Pt on the lower side, the control section 10 determines whether or not the width Y2 of the peripheral area 22n on the lower side is equal to or larger than the width Y0 of the toolbar Pt. Then, when the peripheral area 22n has the sufficient width, and therefore the toolbar Pt can be disposed, the control section 10 makes the transition of the process to the step S108. In contrast, when the toolbar Pt cannot be disposed, namely when the content image Ic and the toolbar Pt overlap each other when disposing the toolbar Pt, the control section 10 makes the transition of the process to the step S105.

When the width of the peripheral area 22n is not sufficient, and thus the transition of the process to the step S105 has been made, the control section 10 determines whether it is sufficient to move the content image Ic, or it is necessary to perform both of the contraction and the translation in order to make it possible to dispose the toolbar Pt. Then, the control section 10 makes the transition of the process to the step S106 when it becomes possible to dispose the toolbar Pt only by moving the content image Ic, or makes the transition of the process to the step S109 when it becomes necessary to perform both of the contraction and the translation.

Specifically, when disposing the toolbar Pt on the upper side or the lower side of the projection image Ip, the control section 10 compares a sum Y1+Y2 of the widths of the peripheral areas 22n located above and below the content image Ic and the width Y0 of the toolbar Pt with each other, and determines that it is sufficient to move the content image Ic when the sum Y1+Y2 is equal to or larger than the width Y0, or determines that both of the contraction and the translation are necessary when the sum Y1+Y2 is smaller than the width Y0. Further, when disposing the toolbar Pt on the left side or the right side of the projection image Ip, the control section 10 compares a sum X1+X2 of the widths of the peripheral areas 22n located on the right and the left of the content image Ic and the width X0 of the toolbar Pt with each other, and determines that it is sufficient to move the content image Ic when the sum X1+X2 is equal to or larger than the width X0, or determines that both of the contraction and the translation are necessary when the sum X1+X2 is smaller than the width X0.

When it has been determined that the toolbar Pt can be disposed only by moving the content image Ic, and the transition of the process to the step S106 has been made, the control section 10 instructs the image information processing section 16 to move the content image Ic in a necessary direction as much as an amount necessary to dispose the toolbar Pt due to the position adjustment function.

Then, in the step S107, the control section 10 instructs the OSD processing section 14 to move the drawn image Id having already been drawn in the same direction as much amount as those of the content image Ic. Specifically, in order to move the drawn image Id, the OSD processing section 14 changes the position of the drawing area on the frame memory in accordance with the moving amount of the content image Ic to generate the drawn image Id on the new drawing area. It should be noted that it is also possible for the OSD processing section 14 to adjust a shift amount when superimposing the drawn image Id on the content image Ic in the image information combining section 17 instead of moving the drawing area.

In the step S108, the control section 10 instructs the OSD processing section 14 to display the toolbar Pt at the position based on the position information obtained in the step S103, and then terminates the flow.

On the other hand, when it has been determined in the step S105 that both of the contraction and the translation are necessary, and thus the transition of the process to the step S109 has been made, the control section 10 instructs the image information processing section 16 to contract the content image Ic as much as a necessary amount due to the size adjustment function. In other words, the control section 10 contracts the content image Ic to thereby increase the width of the peripheral area 22n. Specifically, when disposing the toolbar Pt on the upper side or the lower side of the projection image Ip, the image information processing section 16 contracts the content image Ic so that the sum Y1+Y2 of the widths of the peripheral areas 22n becomes equal to the width Y0 of the toolbar Pt. Further, when disposing the toolbar Pt on the left side or the right side of the projection image Ip, the image information processing section 16 contracts the content image Ic so that the sum X1+X2 of the widths of the peripheral areas 22n becomes equal to the width X0 of the toolbar Pt.

In the step S110, the control section 10 instructs the image information processing section 16 to move the content image Ic in the necessary direction as much as an amount necessary to dispose the toolbar Pt due to the position adjustment function. Specifically, since one of the sum X1+X2 and the sum Y1+Y2 of the widths of the peripheral areas 22n becomes equal to one of the widths X0, Y0 of the toolbar Pt in the step S109, the valid area 22e is set so as to have contact with a side opposed to the side on which the toolbar Pt is disposed.

In the step S111, the control section 10 instructs the OSD processing section 14 to contract the drawn image Id having already been drawn with the same reduction scale as the content image Ic, and move the drawn image Id in the same direction as much amount as those of the content image Ic. Then, the control section 10 makes the transition of the process to the step S108, and makes the OSD processing section 14 display the toolbar Pt to terminate the flow.

It should be noted that although not shown in the drawings, when the icon for hiding the toolbar Pt is touched in the state in which the toolbar Pt is displayed, the control section 10 instructs the OSD processing section 14 to erase the toolbar Pt and display the button image Ps instead of the toolbar Pt. Further, when the contraction or the translation of the content image Ic and the drawn image Id has been performed when displaying the toolbar Pt, the control section 10 instructs the image information processing section 16 and the OSD processing section 14 to restore the size or the position of the content image Ic and the drawn image Id.

Then, an operation of the projector 1 when the resolution of the content image Ic supplied to the projector 1 has changed will be described.

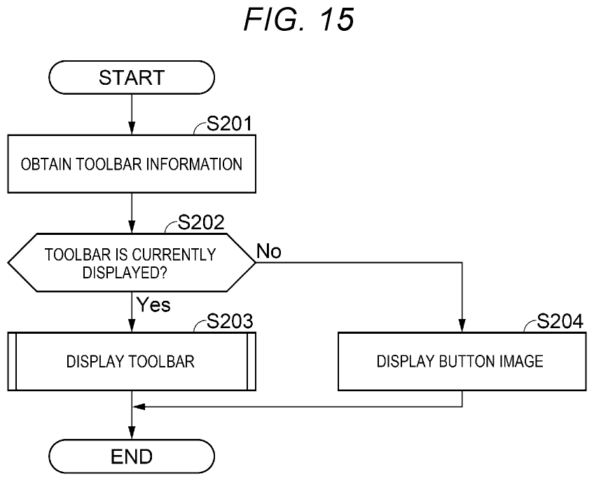

FIG. 15 is a flowchart showing the operation of the projector 1 when the resolution of the content image Ic has changed. When the resolution of the content image Ic has changed such as when the image supply device 3 has changed the resolution of the content image Ic, or when the image supply device 3 for supplying the projector 1 with the content image Ic has been switched to another image supply device 3, the control section 10 operates in accordance with the flow shown in FIG. 15.

As shown in FIG. 15, in the step S201, the control section 10 obtains the toolbar information stored in the storage section 11. Then, in the step S202, the control section 10 determines the display state of the toolbar Pt, namely whether the toolbar Pt is currently displayed or hidden, based on the toolbar information thus obtained. The control section 10 makes the transition of the process to the step S203 when the toolbar Pt is currently displayed, or makes the transition of the process to the step S204 when the toolbar Pt is hidden.

When the toolbar Pt is currently displayed, and thus, the transition of the process to the step S203 has been made, the control section 10 performs the process (see FIG. 11) of displaying the toolbar Pt, and then terminates the flow. Specifically, the control section 10 contracts or moves the content image Ic as needed so that the toolbar Pt does not overlap the content image Ic, and then displays the toolbar Pt.

In contrast, when the toolbar Pt is hidden, and, the transition of the process to the step S204 has been made, the control section 10 instructs the image information processing section 16 to form the content image Ic in the maximum size in the pixel area 22i, and at the same time instructs the OSD processing section 14 to display the button image Ps, and then terminates the flow. When the OSD processing section 14 outputs the image information of the button image Ps to the image information combining section 17 in response to the instruction, the button image Ps is displayed so as to be superimposed on the content image Ic.

As described hereinabove, according to the image display system 100, the projector 1 and the method of controlling these related to the present embodiment, the following advantages can be obtained.

(1) According to the present embodiment, the OSD processing section 14 changes the size and the position of the drawn image Id in tandem with the change in the size and the position of the content image Ic in the steps S107, S111. Therefore, even when the size and the position of the content image Ic have been changed, it is possible to suppress the misalignment occurring between the content image Ic and the drawn image Id.

(2) According to the present embodiment, since the image information processing section 16 changes at least one of the size and the position of the content image Ic so that the content image Ic does not overlap with the toolbar Pt, the toolbar Pt is prevented from hiding apart of the content image Ic, and thus, the visibility of the content image Ic is prevented from deteriorating.

(3) According to the present embodiment, the image information processing section 16 changes the size or the position of the content image Ic when the toolbar Pt cannot be disposed in the peripheral area 22n of the content image Ic. In other words, when the toolbar Pt can be disposed in the peripheral area 22n, the size and the position of the content image Ic are not changed. Therefore, it is possible to prevent the size or the position of the content image Ic from frequently changing.

It should be noted that in the embodiment described above, the content image Ic corresponds to a first image, the drawn image Id corresponds to a second image, and the toolbar Pt corresponds to a third image.

### Modified Examples

Further, the embodiment described above can also be modified as follows.

In the embodiment described above, the OSD processing section 14 changes the size or the position of the drawn image Id in tandem with the change in the size or the position of the content image Ic, but this aspect is not a limitation. For example, when the projector 1 has the size adjustment function, but does not have the position adjustment function, it is sufficient for the OSD processing section 14 to change the size of the drawn image Id in tandem with the change in the size of the content image Ic. In contrast, when the projector 1 has the position adjustment function, but does not have the size adjustment function, it is sufficient for the OSD processing section 14 to change the position of the drawn image Id in tandem with the change in the position of the content image Ic.

In the embodiment described above, it is arranged that the contraction of the content image Ic is performed as needed when disposing the toolbar Pt (see the step S109 in FIG. 11). However, it is also possible to arrange that the projector 1 changes the size or the position of the content image Ic by changing the EDID instead of making the content image Ic be contracted. Specifically, the EDID memory 15b generally stores the resolution of the entire area of the pixel area 22i as the EDID, and in the step S109, the control section 10 changes the resolution stored as the EDID to the resolution of the area obtained by excluding the area where the toolbar Pt is disposed from the entire area of the pixel area 22i.

As a result, since the image supply device 3 starts the supply of the image information with the resolution corresponding to the new EDID, it becomes possible for the projector 1 to dispose the toolbar Pt in the peripheral area 22n without contracting the content image Ic, and thus, it becomes possible to prevent the deterioration of the content image Ic due to the contraction. In the case of this configuration, the control section 10 changing the EDID corresponds to the first processing section for changing at least one of the size and the position of the content image Ic. It should be noted that it is also possible to arrange that the control section 10 rewrites the EDID when changing the EDID, but it is also possible to arrange that a plurality of EDID is stored in the EDID memory 15d in advance, and the control section 10 switches to the EDID for valid out of the EDID. Further, when the toolbar Pt is hidden, the control section 10 restores the EDID.

In the embodiment described above, the image information combining section 17 combines the first layer including the content image Ic and the second layer including the OSD image with each other, but this aspect is not a limitation. For example, it is arranged that the OSD processing section 14 generates the OSD image while separating a layer in which the drawn image Id is generated from a layer in which the OSD image except the drawn image Id is generated, and the image information combining section 17 combines the first layer including the content image Ic, the second layer including the drawn image Id and a third layer including the rest of the OSD image with each other.

In the embodiment described above, there is described the aspect in which the contraction or the translation of the content image Ic is performed when displaying the toolbar Pt, but it is also possible to arrange that the contraction or the translation of the content image Ic is performed when displaying the OSD image other than the toolbar Pt, such as the menu image or the message image.

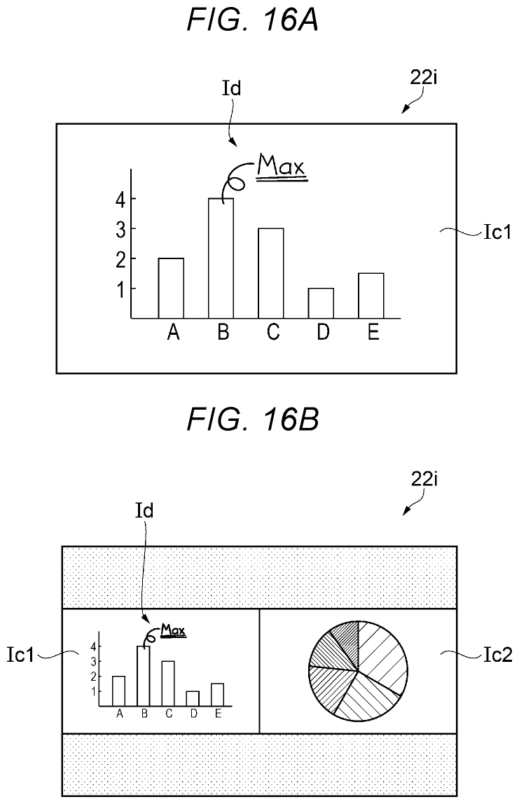

In the embodiment described above, there is described the aspect in which the size or the position of the drawn image Id is changed in tandem with the change in the size or the position of the content image Ic due to the display of the toolbar Pt, but this aspect is not a limitation. For example, when adopting a configuration in which the size adjustment function or the position adjustment function can be performed based on the input operation by the user to the input operation section 12, namely a configuration in which the content image Ic can be disposed in a desired size at a desired position by the user operating the input operation section 12, it is possible to change the size or the position of the drawn image Id in tandem with the input operation by the user. Further, in a configuration capable of multi-screen display of displaying a plurality of content image Ic supplied from a plurality of image supply devices 3 side by side, it is possible to arrange that the size or the position of the drawn image Id is changed in tandem with the change in the size or the position of one of the content images Ic due to the multi-screen display. For example, when switching between the state (see FIG. 16A) in which a first content image Ic1 is displayed alone and the state (see FIG. 16B) of the multi-screen display of displaying the first content image Ic1 and a second content image Ic2 side by side, it is possible to arrange that the size and the position of the drawn image Id are changed in tandem with the change in the size and the position of the first content image Ic1.

Although in the embodiment described above, the transmissive liquid crystal light valves 22R, 22G and 22B are used as the light modulation devices, it is also possible to use reflective light modulation devices such as reflective liquid crystal light valves. Further, it is also possible to use a digital mirror device or the like for modulating the light emitted from the light source 21 by controlling the emission direction of the incident light for every micromirror as a pixel. Further, the configuration of providing the plurality of light modulation devices for the respective colored light beams is not a limitation, but it is also possible to adopt a configuration of modulating the plurality of colored light beams with a single light modulation device in a time-sharing manner.

Although in the embodiment described above, the projector 1 is described as an example of the image display device, the image display device is not limited to the projector 1, but can also be other image display devices such as a liquid crystal display or an organic EL display. Further, the device for generating the drawn image Id is not limited to the light emitting pen 2, and it is possible to adopt a pointing device such as a mouse or a digitizer, or it is also possible to adopt a touch panel configured integrally with a display surface.

Hereinafter, the contents derived from the embodiment will be described.

The image display device is an image display device configured to display an image on a display surface and to include an input section supplied with a first image, a detection section configured to detect a pointing position pointed with a pointing body above the display surface, a generation section configured to generate a second image based on a trajectory of the pointing position detected by the detection section, a combining section configured to combine the second image with the first image, a display section configured to display the first image and the second image combined with each other by the combining section on the display surface, a first processing section configured to change at least one of a size and a position of the first image supplied to the input section, and a second processing section configured to make a change corresponding to the change to be made to the first image by the first processing section to the second image generated by the generation section.

According to this configuration, when the change is made to at least one of the size and the position of the first image, the second processing section also makes the corresponding change to the second image, and therefore, it is possible to suppress the misalignment occurring between the first image and the second image.

In the image display device described above, the second processing section changes a size of the second image when the size of the first image is changed.

According to this configuration, when the size of the first image has been changed, the size of the second image is also changed, and therefore, it is possible to suppress the misalignment occurring between the first image and the second image.

In the image display device described above, the second processing section changes a position of the second image when the position of the first image is changed.

According to this configuration, when the position of the first image has been changed, the position of the second image is also changed, and therefore, it is possible to suppress the misalignment occurring between the first image and the second image.

In the image display device described above, when displaying a third image next to the first image, the first processing section may change at least one of the size and the position of the first image so that the third image fails to overlap the first image.

According to this configuration, since the first processing section changes the size or the position of the first image to thereby prevent the third image from overlapping the first image, the third image is prevented from hiding a part of the first image, and thus, the deterioration of the visibility of the first image is prevented.

In the image display device described above, the third image may be an operation image configured to assist an operation by a user.

According to this configuration, even when displaying the operation image for assisting the operation by the user, there is no chance for the operation image to hide the first image.

In the image display device described above, the display section may have an image formation section in which the first image and the second image combined with each other by the combining section are formed, and the first processing section may change at least one of the size and the position of the first image when the first image and the third image overlap each other when disposing the third image in a peripheral area located outside the first image in the image formation section.

According to this configuration, the first processing section changes the size or the position of the first image when the first image and the third image overlap each other when disposing the third image in the peripheral area located outside the first image. In other words, when the first image and the third image fail to overlap each other, the size and the position of first image are not changed. Therefore, it is possible to prevent the size or the position of the first image from frequently changing.

In the image display device described above, there may further be included a resolution information storage section configured to store resolution information corresponding to resolution of the image formation section, the first image may be input to the input section with the resolution based on the resolution information by an image supply device which obtains the resolution information from the resolution information storage section, and the first processing section may change the resolution information in accordance with resolution of an area obtained by excluding an area in which the third image is disposed from the image formation section when changing the size of the first image.

According to this configuration, when changing the size of the first image, the resolution information is changed in accordance with the resolution of the area obtained by excluding the area in which the third image is disposed from the image formation section. As a result, since the image supply device supplies the first image with the resolution corresponding to the resolution information having been changed, it becomes unnecessary for the image display device to perform the process of contracting the first image, and thus, it becomes possible to prevent the deterioration of the image due to the contraction of the image.

The method of controlling an image display device is a method of controlling an image display device configured to display an image on a display surface and to include the steps of receiving, by the image display device, supply of a first image, detecting, by the image display device, a pointing position pointed with a pointing body above the display surface, generating, by the image display device, a second image based on a trajectory of the pointing position, combining, by the image display device, the second image with the first image, displaying, by the image display device, the first image and the second image combined with each other on the display surface, and making, by the image display device, a change corresponding to a change made to the first image to the second image when making the change to at least one of a size and a position of the first image supplied.

According to this configuration, when the change is made to at least one of the size and the position of the first image, the image display device also makes the corresponding change to the second image, and therefore, it is possible to suppress the misalignment occurring between the first image and the second image.

In the method of controlling the image display device described above, when changing the size of the first image, the image display device changes a size of the second image.

According to this configuration, when the size of the first image has been changed, the size of the second image is also changed, and therefore, it is possible to suppress the misalignment occurring between the first image and the second image.

In the method of controlling the image display device described above, when changing the position of the first image, the image display device changes a position of the second image.

According to this configuration, when the position of the first image has been changed, the position of the second image is also changed, and therefore, it is possible to suppress the misalignment occurring between the first image and the second image.

In the method of controlling the image display device described above, when displaying a third image next to the first image, the image display device may change at least one of the size and the position of the first image so that the third image fails to overlap the first image.

According to this configuration, since the image display device changes the size or the position of the first image to thereby prevent the third image from overlapping the first image, the third image is prevented from hiding a part of the first image, and thus, the deterioration of the visibility of the first image is prevented.

In the method of controlling the image display device described above, the third image may be an operation image configured to assist an operation by a user.

According to this configuration, even when displaying the operation image for assisting the operation by the user, there is no chance for the operation image to hide the first image.

In the method of controlling the image display device described above, the image display device may form the first image and the second image in an image formation section to thereby display the first image and the second image on the display surface, and the image display device may change at least one of the size and the position of the first image when the first image and the third image overlap each other when disposing the third image in a peripheral area located outside the first image in the image formation section.

According to this configuration, the image display device changes the size or the position of the first image when the first image and the third image overlap each other when disposing the third image in the peripheral area located outside the first image. In other words, when the first image and the third image fail to overlap each other, the size and the position of first image are not changed. Therefore, it is possible to prevent the size or the position of the first image from frequently changing.

In the method of controlling the image display device described above, the image display device may further include a resolution information storage section configured to store resolution information corresponding to resolution of the image formation section, the image display device may receive supply of the first image with the resolution based on the resolution information by an image supply device which obtains the resolution information from the resolution information storage section, and the image display device may change the resolution information in accordance with resolution of an area obtained by excluding an area in which the third image is disposed from the image formation section when changing the size of the first image.

According to this configuration, when changing the size of the first image, the resolution information is changed in accordance with the resolution of the area obtained by excluding the area in which the third image is disposed from the image formation section. As a result, since the image supply device supplies the first image with the resolution corresponding to the resolution information having been changed, it becomes unnecessary for the image display device to perform the process of contracting the first image, and thus, it becomes possible to prevent the deterioration of the image due to the contraction of the image.

What is claimed is:

1. An image display device configured to display an image on a display surface, the image display device comprising:
an input section supplied with a first image;
a detection section configured to detect a pointing position pointed with a pointing body above the display surface;
a generation section configured to generate a second image based on a trajectory of the pointing position detected by the detection section;
a combining section configured to combine the second image with the first image;
a display section configured to display the first image and the second image combined with each other by the combining section on the display surface;
a first processing section configured to change at least one of a size and a position of the first image supplied to the input section; and
a second processing section configured to make a change corresponding to the change to be made to the first image by the first processing section to the second image generated by the generation section.

2. The image display device according to claim 1, wherein
the second processing section changes a size of the second image when the size of the first image is changed.

3. The image display device according to claim 1, wherein
the second processing section changes a position of the second image when the position of the first image is changed.

4. The image display device according to claim 1, wherein
when displaying a third image next to the first image, the first processing section changes at least one of the size and the position of the first image so that the third image fails to overlap the first image.

5. The image display device according to claim 4, wherein
the third image is an operation image configured to assist an operation by a user.

6. The image display device according to claim 4, wherein
the display section has an image formation section in which the first image and the second image combined with each other by the combining section is formed, and
the first processing section changes at least one of the size and the position of the first image when the first image and the third image overlap each other when disposing the third image in a peripheral area located outside the first image in the image formation section.

7. The image display device according to claim 4, further comprising:
a resolution information storage section configured to store resolution information corresponding to resolution of the image formation section, wherein
the first image is input to the input section with the resolution based on the resolution information by an image supply device which obtains the resolution information from the resolution information storage section, and
the first processing section changes the resolution information in accordance with resolution of an area obtained by excluding an area in which the third image is disposed from the image formation section when changing the size of the first image.

8. A method of controlling an image display device configured to display an image on a display surface, the method comprising:
receiving, by the image display device, supply of a first image;
detecting, by the image display device, a pointing position pointed with a pointing body above the display surface;
generating, by the image display device, a second image based on a trajectory of the pointing position;
combining, by the image display device, the second image with the first image;
displaying, by the image display device, the first image and the second image combined with each other on the display surface; and
making, by the image display device, a change corresponding to a change made to the first image to the second image when making the change to at least one of a size and a position of the first image supplied.

9. The method of controlling the image display device according to claim 8, wherein
when changing the size of the first image, the image display device changes a size of the second image.

10. The method of controlling the image display device according to claim 8, wherein
when changing the position of the first image, the image display device changes a position of the second image.

11. The method of controlling the image display device according to claim 8, wherein
when displaying a third image next to the first image, the image display device changes at least one of the size and the position of the first image so that the third image fails to overlap the first image.

12. The method of controlling the image display device according to claim 11, wherein
the third image is an operation image configured to assist an operation by a user.

13. The method of controlling the image display device according to claim 11, wherein
the image display device forms the first image and the second image in an image formation section to thereby display the first image and the second image on the display surface, and
the image display device changes at least one of the size and the position of the first image when the first image and the third image overlap each other when disposing the third image in a peripheral area located outside the first image in the image formation section.

14. The method of controlling the image display device according to claim 11, wherein
the image display device further includes a resolution information storage section configured to store resolution information corresponding to resolution of the image formation section,
the image display device receives supply of the first image with the resolution based on the resolution information by an image supply device which obtains the resolution information from the resolution information storage section, and
the image display device changes the resolution information in accordance with resolution of an area obtained by excluding an area in which the third image is disposed from the image formation section when changing the size of the first image.
